(19) United States
(12) Patent Application Publication
(10) Pub. No.: US 2026/0370471 A1
(43) Pub. Date: Nov. 19, 2026

(54) COMPUTER-IMPLEMENTED METHODS AND SYSTEMS

(71) Applicant: nChain Licensing AG, Zug (CH)

(72) Inventors: Katharine MOLLOY, London (GB); Owen VAUGHAN, London (GB); Craig Steven WRIGHT, London (GB)

(21) Appl. No.: 19/138,610

(22) PCT Filed: Nov. 28, 2023
(86) PCT No.: PCT/EP2023/083336

§ 371 Date: Jun. 12, 2025

(30) Foreign Application Priority Data
Dec. 14, 2022 (GB) 2218829.6

(51) Int. Cl. H04L 9/32; G06Q 20/38; G06Q 20/40; H04L 9/00; H04L 9/30

(52) U.S. Cl. CPC H04L 9/3213; G06Q 20/3823; G06Q 20/389; G06Q 20/401; H04L 9/30; H04L 9/3218; H04L 9/3236; H04L 9/3247; H04L 9/50; H04L 2209/56

(57) ABSTRACT

A computer-implemented method of issuing digital tokens using a blockchain, wherein the method is performed by a token issuer and comprises: sending an issuance transaction to one or more nodes of a blockchain network, wherein the issuance transaction is signed by the token issuer and comprises a first identifier, the first token identifier being based on at least first token data related to a first token; obtaining a first proof of inclusion proving the issuance transaction has been recorded on the blockchain; and maintaining a database, wherein the database comprises the first token identifier mapped to the issuance transaction and the first proof of inclusion, wherein the database is made available to one or more token users.

### CROSS REFERENCE TO RELATED APPLICATIONS

This application is the U.S. National Stage of International Application No. PCT/EP2023/083336 filed on Nov. 28, 2023, which claims the benefit of United Kingdom Patent Application No. 2218829.6, filed on Dec. 14, 2022, the contents of which are all incorporated herein by reference in their entireties.

### TECHNICAL FIELD

The present disclosure relates to methods and systems for issuing and validating blockchain-based digital tokens.

### BACKGROUND

One emerging use of the blockchain is to issue ‘tokens’. A token may represent, for example, a certain amount of fiat currency within a central bank digital currency (CBDC) system, a digital ID, a unique piece of digital art, an event ticket, a share of a company, a physical asset such as material within a supply chain, etc.

To verify whether a transaction containing a token is valid, one typically must verify that the transaction satisfies both the ruleset defined by the relevant token system and the underlying blockchain rules. It is also necessary to verify the ‘provenance’ of the token, i.e., its history since issuance. This process becomes harder as each new transaction is generated for a token, as the distance between token issuance and the current transaction grows. This is known as the back-to-genesis problem or the traceback problem.

Consider the example chain of transactions shown in FIG. 5. In this simplest case each transaction has one input and one output. The first transaction, Tx₀, is the issuance transaction, which creates (mints) the token. Each subsequent transaction spends the output of the previous transaction and represents the transfer of ownership of the token. This is referred to as a transaction chain. Suppose a recipient is presented with transaction Txₙ, which is valid under both the blockchain and token rulesets. The recipient must also verify that Txₙ is part of an unbroken chain of transactions Tx₀, . . . , Txₙ, originating from the issuance transaction, and that all preceding transactions in the chain, Tx₀, . . . , Txₙ₋₁, are valid under both the blockchain and token rules. There are currently several approaches to verifying the token chain, as detailed below in section 3.3. Each has its associated problems. The present disclosure provides a novel solution which addresses these problems.

### SUMMARY

According to one aspect disclosed herein, there is provided a computer-implemented method of issuing digital tokens using a blockchain, wherein the method is performed by a token issuer and comprises: sending an issuance transaction to one or more nodes of a blockchain network, wherein the issuance transaction is signed by the token issuer and comprises a first identifier, the first token identifier being based on at least first token data related to a first token; obtaining a first proof of inclusion proving the issuance transaction has been recorded on the blockchain; and maintaining a database, wherein the database comprises the first token identifier mapped to the issuance transaction and the first proof of inclusion, wherein the database is made available to one or more token users.

According to another aspect disclosed herein, there is provided a computer-implemented method of validating digital tokens issued using a blockchain, wherein the blockchain comprises an issuance transaction signed by a token issuer and comprising a first token identifier, the first token identifier being based on at least first token data related to a first token, and wherein the method is performed by a token validator and comprises: obtaining a target transfer transaction, wherein the target transfer is a final transaction of a chain of one or more respective transfer transactions linked back to the issuance transaction, and wherein the target transfer transaction comprises the first token identifier; obtaining a database, wherein the database comprises the first token identifier mapped to the issuance transaction, a first proof of inclusion proving the issuance transaction has been recorded on the blockchain, and a target proof of inclusion proving that the target transfer transaction has been recorded on the blockchain; and determining that the target transfer transaction comprises a valid token by performing at least the following: i) using the first proof of inclusion to verify that the issuance transaction has been recorded on the blockchain, ii) using the target proof of inclusion to verify that the target transfer transaction has been recorded on the blockchain, and iii) verifying that the target transfer transaction is linked to the issuance transaction.

Embodiments of the present disclosure provide techniques for issuing tokens that can be validated efficiently, and techniques for efficiently validating said tokens.

The described token system allows “offline” transfers of tokens as the transfers do not require the involvement of (and therefore connection to) a central authority (i.e. token issuer). All of the information required to validate to validate a token is made available to the token recipient by way of a (distributed) hash table which may be shared peer-to-peer amongst token users.

The database (e.g. a hash table) stores Merkle proofs of the issuance and transfer transactions, which can be used to prove that a target (e.g. most recent) transfer transaction has been recorded on the blockchain. By verifying that the target transfer transaction and the issuance transaction have been recorded on the blockchain, and that the target transfer transaction is linked to the issuance transaction, a token recipient can be certain of the provenance of the associated token. For added certainty, the token recipient may verify the existence of each transaction in the chain of transactions linking the target transfer transaction to the issuance transaction.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain,

FIG. 3 is a schematic block diagram of an example system for issuing and validating tokens,

FIG. 4 schematically illustrates a chain of token transactions,

FIG. 5 schematically illustrates a chain of token transactions,

FIG. 6 schematically illustrates an example Merkle tree, and

FIG. 7 schematically illustrates an example Merkle path for the Merkle tree shown in FIG. 6.

### DETAILED DESCRIPTION OF EMBODIMENTS

### 1. Issuing and Validating Tokens

As an illustrative example, consider a central authority (e.g. a central bank) that wishes to issue tokens (e.g. digital currency). However, a problem arises if the token is to be transferred without the central authority signing the transaction (which has the benefit of making the process easy and efficient), since without the central authority's signature the recipient of the token cannot be sure that the token is valid. Instead, the recipient must trace the received (i.e. most recent) transaction back to the issuance transaction that issued the token. This is resource intensive, and is referred to as the trace back problem/back-to-genesis problem.

The central authority may choose to issue tokens as fungible tokens. However, a problem with fungible tokens is that for any given token transaction, the transaction may reference multiple previous transactions. As a token is transferred more and more, there becomes an increasingly growing number of transactions to check.

The central authority may therefore choose to issue non-fungible tokens instead. Now, every token has only one previous transaction, or more accurately, each token is associated with only one input (and therefore only previous transaction output). Note that a given token transaction may still contain multiple tokens. The task of checking the transaction chain therefore becomes linear in size of the chain back to issuance. In other words, compared to fungible tokens, there are less previous transactions to check for validity.

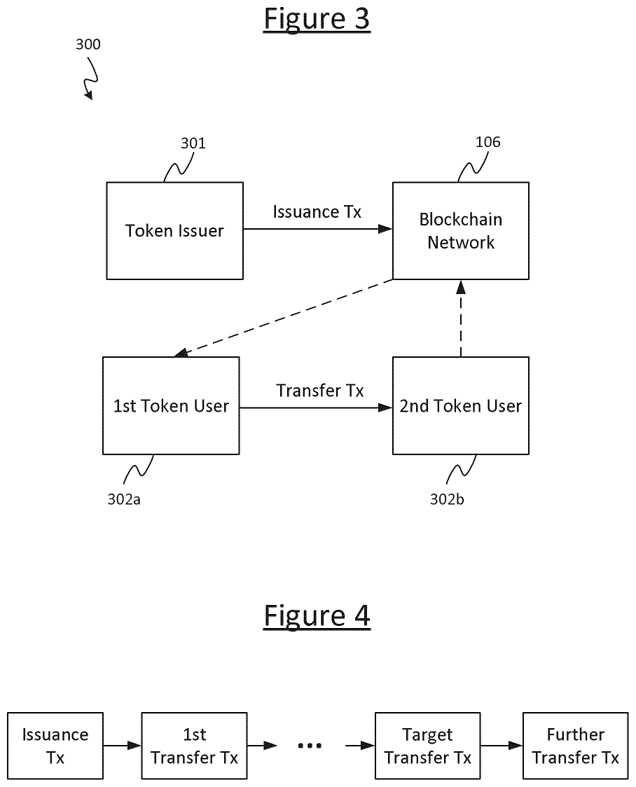

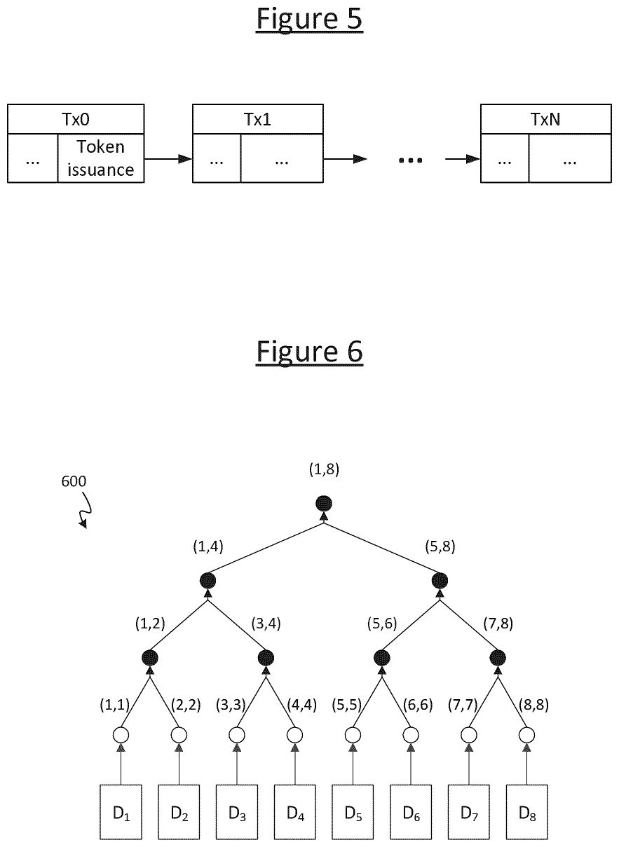

Embodiments described herein provide an efficient mechanism for validating tokens. FIG. 3 illustrates an example system 300 for implementing the described embodiments. The system 300 includes a token issuer 301 responsible for issuing tokens according to a token protocol and a plurality of token users 302. Only two token users 302a, 302b are shown but it will be appreciated that the system 300 may comprise any number of token users 302. The system 300 also includes one or more nodes 104 of a blockchain network 106, e.g. the example network 106 described below. For simplicity, the first token user 302a will be referred to as Alice 103a and the second token user 302b will be referred to as Bob 103b. In general, each token user 302 may be configured to perform any of the actions described below as being performed by Alice 103a and/or Bob 103b.

The token issuer 301 may be any type of entity, e.g. a user, a group of users, a company, a government institution, a bank, an event operator, etc. The token issuer 301 may issue any number of tokens but for simplicity the embodiments will be described in terms of issuing a single token.

The token issuer 301 generates an issuance transaction for issuing a token. The token may be a non-fungible token. The issuance transaction contains a token identifier value (e.g. a token hash value). The token identifier is a unique (and preferably succinct) identifier of the token. For example, the token hash value may be generated by hashing token data related to the token. In this example, the token data itself may include an identifier of the token, but not the hash value. The token data may include rules of the token protocol. The token data may define one or more properties of the token. The token data may be included in the transaction, or stored elsewhere, either on-chain or off-chain. Other examples of the token identifier include a Pederson commitment of the token data, or a uniform resource locator (URL) that references the token data, e.g. a webpage containing the token data. In general, any commitment or reference to the token data may be used so long as it is unique to the corresponding token.

The issuance transaction is signed by the token issuer 301. That is, the issuance transaction includes a signature generated using a private key controlled by the token issuer 301. The private key may correspond to a public key known to be associated with the token issuer 301. The public key may be certified as being associated with the token issuer 301.

The issuance transaction may be locked to a recipient, e.g. Alice 103a. That is, in order to transfer the token, Alice 103a may have to provide data which only Alice 103a can provide. In some examples, the issuance transaction may be locked to the token issuer 301 instead, or additionally. In the former case, the first transfer transaction (described below) is created by the token issuer 301 and transfers the token to a token user 302 such as Alice 103a.

When using a UTXO-based blockchain, the issuance transaction may have an input (a “token input”) that includes the token issuer's signature, and an output (a “token output”) locked to a public key of the recipient, e.g. Alice's public key. The token hash may be included a spart of the token output, or as part of a different output. The token input and token output may be linked, e.g. they may occupy the same position in the list of inputs and list of outputs of the transaction. That is, they may have the same input index and output index. As an example, the token input may be the first input of the transaction and the token output may be the first output of the transaction. In some examples, the token issuer's signature may sign the token output, or rather a message based on the token output. In some examples, the signature does not sign other inputs and/or outputs.

The token issuer 301 sends the issuance transaction to the blockchain network 106. After he issuance transaction has been recorded on the blockchain 150, the token issuer 301 obtains (e.g. generates or receives from a blockchain node 104) a Merkle proof proving that the issuance transaction has been recorded on the blockchain 150. Other inclusion proofs may be used instead of Merkle proofs. Note that “Merkle proof” is being used to refer to any Merkle-like proof.

The token issuer 301 maintains a database, such as a hash table. The hash table may be a distributed hash table. The database is available to the token users 302. For example, the token issuer 301 may send the database to the token users 302. The database may be stored online (e.g. in cloud storage) such that it can be accessed by the token users 302. Examples will primary be described in terms of a hash table but in general any suitable type of database which allows for look-up operations may be used. Unless the context requires otherwise, any mention of “hash table” may be replaced with “database” and any mention of “hash value” or “token hash” may be replaced with “token identifier”.

The hash table contains the token hash (from the issuance transaction) mapped to the issuance transaction and the Merkle proof of the issuance transaction. Again, in general any database may be used, with the token identifier being mapped to the issuance transaction and corresponding Merkle proof. The hash table is used by token users 302 to validate token transactions, as will be described below.

Before moving to validation, as mentioned above, the token issuer 301 itself may transfer the token to a token user 302, e.g. Alice 103a. For example, the token issuer 301 may generate a transfer transaction that refences the issuance transaction. The transfer transaction is signed by the token issuer 301. The transfer transaction may be locked to a public key associated with Alice 103a. When using a UTXO-based blockchain, the transfer transaction has a token input that references the token output of the issuance transaction and includes the token issuer's signature. The transfer transaction includes a token output (linked to the token input) that is locked to Alice's public key, e.g. using a pay-to-public-key (P2PK) or pay-to-public-key-hash (P2PKH) locking script. The transfer transaction includes the token hash.

The token issuer 301 sends the transfer transaction to the blockchain network 106 to be recorded on the blockchain 150. Alternatively, the token issuer 301 may send the transfer transaction to Alice 103a who sends it to the blockchain network 106. Regardless, the token issuer obtains a Merkle proof proving that the transfer transaction has been recorded on the blockchain 150. The token issuer 301 updates the hash table by mapping the token hash to the transfer transaction and the Merkle proof of the transfer transaction.

Similarly, each time a transfer transaction is submitted to the blockchain 150 to transfer the token between token users 302, e.g. from Alice 103a to Bob 103b, the token issuer 301 obtains the transfer transaction(s) and corresponding Merkle proof(s) and updates the database (e.g. hash table) to map the transfer transaction(s) and Merkel proof(s) to the token hash.

It will be appreciated that the database (e.g. hash table) may contain many token identifiers (token hashes), each related to a particular token, and each mapped to one or more transactions and one or more corresponding Merkle proofs.

Turning now to the process of validating a token. A token validator (e.g. a token user such as Alice 103a) obtains a target transfer transaction. For example, Alice 103a may receive the target transaction from the token issuer 301 or a different token user 302. The target transfer transaction may have a token output locked to Alice's public key 103a. The target transfer transaction includes a token hash. The target transfer transaction may contain other token-related data, e.g. an identifier of the token.

Alice 103a obtains from the database (e.g. hash table) maintained by the token issuer 301 and using the token identifier (e.g. token hash), an issuance transaction and a Merkle proof thereof. Alice 103a also obtains a Merkle proof for the target transfer transaction.

Using the Merkle proofs, Alice 103a verifies that the issuance transaction and the target transfer transaction have been recorded on the blockchain 150. Note again that other inclusion proofs may be used instead of Merkle proofs. Alice 103a may require block headers of the blockchain 150. One or more block headers may be obtained from the token issuer 301. One or more block headers may be obtained from a blockchain node 104. Alice 103a may already have a list of block headers.

Alice 103a also verifies that the target transfer transaction is linked to the issuance transaction. That is, Alice 103a verifies that the target transfer transaction is part of a transaction chain beginning with the issuance transaction (note that the issuance transaction does not necessarily have to be the very start of the chain, which is typically a coinbase/generation transaction). If the verifications pass, Alice 103a may determine that the target transfer transaction is a valid token transaction and contains a valid token issued by the token issuer 301.

In some examples, Alice 103a may verify that the target transfer transaction is linked to the issuance transaction by obtaining each of the transfer transactions connecting the target transfer transaction to the issuance transaction. The transactions may be obtained from the hash table. If the hash table contains respective Merkle proofs of the respective transactions, Alice 103a may also verify that each of the respective transactions has been recorded on the blockchain 150.

Upon determining that the target transfer transaction is valid, Alice 103a may generate a new transfer transaction transferring the token to a different token user 302, e.g. Bob 103b. The new transfer transaction is signed by Alice 103a. That is, Alice 103a generates a signature, using her private key, that signs over at least part of the new transfer transaction. The signature may be included in a token input of the new transfer transaction and used to unlock the token output of the target transfer transaction. The new transfer transaction may be locked to Bob's public key. E.g. a token output of the new transfer transaction may comprise a (P2PK or P2PKH) locking script that locks the output to Bob's public key. The new transfer transaction also includes the token hash, e.g. as part of the token output or a different output.

Alice 103a sends the new transfer transaction to Bob 103b and/or to the blockchain network 106. Bob 103b may perform a similar process to Alice 103a to validate the new transfer transaction.

An example transaction chain created according to the described embodiments is sown in FIG. 4. The transaction chain begins with an issuance transaction, includes one or more transfer transactions connecting the issuance transaction to the target transfer transaction, and ends with a new (further) transfer transaction.

The back-to-genesis problem is reduced when using non-fungible tokens (NFT) compared to fungible tokens. For an NFT there is a single input linked causally to the new token output, so to verify the token history one need only verify a single input. For fungible tokens, the new token output is not provably mapped to a single input, so in order to prove the transaction is valid, one must verify every input. In the context of a CBDC, using NFTs with fixed denominations may mean more tokens pairs are required within a transaction to create the correct total value. This is a one-time cost in terms of increasing the number of inputs to check, but each input will still have a linear transaction chain history.

The token system described herein allows a validator to prove the validity of a token while placing minimal computational burden on token issuers or blockchain nodes 104. It does not require a trusted third party and it allows users 302 to verify a token transaction chain without running a full node (i.e. lightweight data storage and computational power)—suitable to run on a mobile or laptop.

Tokens may be UTXO-based NFTs that represent fixed denominations. Token ownership and transfer may be controlled via locking scripts (e.g. P2PKH). UTXOs may be signed using the single, anyone can pay (S|ACP) sighash flag.

A hash is included in each transaction (e.g. using OP_RETURN) which is linked to an external distributed hash table (maintained by token issuer, shared peer-to-peer amongst users e.g. via torrent). The hash table contains transaction data for each transaction in token chain and a Merkle proof thereof. The hash table may also contain token identifier data, and optionally additional token data e.g. relating to token functionality. The data is mapped to the hash of the token data so that a user can look up the relevant proof and data using the hash value.

A token user 302 maintains a list of block headers. On receipt of token transaction, the user 302 performs a look-up using the hash value included in the transaction to access the token data and validation proof. The user may check each transaction in the chain is valid according to the blockchain and token rulesets. The user may perform a Merkle proof oe each transaction in the chain. As a minimum, the user performs a Merkle proof of the issuance transaction and the received transaction.

The described token system is more efficient compared to systems like ‘transaction chain proof’ or ‘miner-validated tokens’ where the proof size and complexity is independent of chain length.

### 2. Cryptographic Techniques

### 2.1 Simple Payment Verification

Traditionally, in order to validate a transaction within the blockchain network 106, one must download the full blockchain history and validate every block (and all transactions within each block) that has come before. This is a time- and resource-heavy process that not all users of the blockchain network 106 can or want to perform. Simple payment verification (SPV) protocols have been defined that facilitate a more ‘lightweight’ client that can verify individual transactions without needing to host the full blockchain database. This allows an SPV client to verify that a new transaction, Txₙ, is valid based on the following:
Full transaction data for proposed transaction Txₙ
Full transaction data for all input transactions to Txₙ (i.e., all transactions in which UTXOs that are used as inputs in Txₙ were created)
Merkle proofs for all input transactions
Blockchain block headers

During verification, each input to Txₙ is verified by comparing the transaction data and Merkle proof with the block header data. Examples of methods for this verification can be found, for example, in Section 8 of the Bitcoin whitepaper. By verifying the Merkle proofs of all input transactions and running signature verification on Txₙ, an SPV client can prove that Txₙ is valid.

Note that SPV systems do not necessarily preclude double-spend attempts, but they do allow these attempts to be identified.

Two important features of SPV systems are that they allow peer-to-peer (P2P) transactions (for instance using the IPv6 protocol), and that it is possible for the services to function offline, i.e. without a permanent connection to the blockchain network 106. These factors enable functions and services to be built upon the blockchain 150 that have the capability to scale.

### 2.2 Merkle Proofs

According to some blockchain protocols, the block header of a block 151 contains a Merkle root of all transactions contained within the block 151. The Merkle root is derived by combining transaction hashes in a Merkle tree structure. An example Merkle tree is shown in FIG. 6.

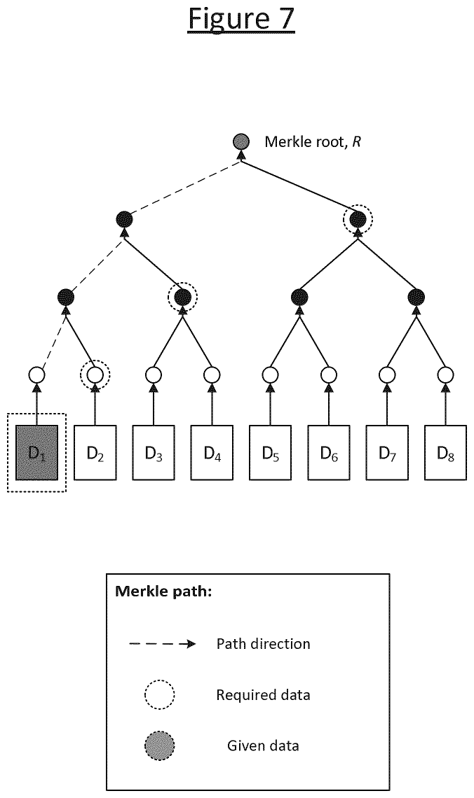

To prove that a certain transaction is part of a block 151, one must recreate the Merkle root using the transaction data. A Merkle proof offers a way to do this without knowing the full details of all the other transactions that were used as data leaves. Instead, at each level of the tree one can calculate the value of one node in the binary pair, and are given the value of the other as part of the Merkle proof. For example, FIG. 7 illustrates the elements necessary to prove that D₁ is in a block 151.

### 3. Example Token Systems

A token system can be encoded on top of the blockchain 150 by including data within transactions. This allows the token system to take advantage of properties of the underlying blockchain 150, such as the immutability of the blockchain ledger, while enabling the functionality of a token system within the ‘second layer’. In order for the token system to integrate with the underlying blockchain 150, the transactions that carry token data must satisfy the ruleset of the blockchain 150.

The token system will have its own ruleset, such that the data stored in transactions can be validated and interpreted. The token ruleset is defined by the token issuer 301, who is also responsible for minting the tokens. Depending on the implementation, the token issuer may also play a role in validating token transactions, melting and re-minting tokens, and hosting data associated with each token.

There is an enormous flexibility when defining token systems. Three major factors that can be used to distinguish between methods of tokenisation are:
Encoding: how the token information is stored within the transaction.
Fungibility: the extent to which the token represents a unique, indivisible asset.
Verification: the method by which tokens are validated.

### 3.1.1 Encoding Mechanisms

A token represents an object within the second-layer system. This may be, for example, a certain amount of fiat currency within a central bank digital currency (CBDC) system, a digital ID, a unique piece of digital art, an event ticket, or a physical asset such as material within a supply chain. Each token may have a unique identifier that may be represented within the transaction, along with other core information relating to the token ruleset, such as the conditions required for transfer. Table 1 illustrates the structure of an example transaction.

TxID

| Version | ver | | In | 1 |
|---|---|---|---|---|
| | | | Count | |
| Locktime | nLocktime | | Out | 2 |
| | | | Count | |
| Inputs | | | Outputs | |
| | Unlocking | | | |
| Outpoint | script | nSeq | Value | Locking script |
| TxID₀ \|\| | < Sig₀ > | n₀ | x₀ | [Checksig PK₁] OP_RETURN |
| Index₀ | < PK₀ > | | | <data> |
| | | | x₁ | [Checksig PK₂] |

### 3.1.2 OP Return

One way to include data within a transaction is using an OP_RETURN (or equivalent) code within the locking script of an output. There is no restriction on the size of data that can be included in this manner, so the data can be represented in full (either in plaintext or encoded). One benefit to this is that all the data required to interpret a token is stored on the blockchain 150, where it is freely accessible and immutable. However, since the transaction fee is proportionate to the size of the transaction, a more economical option is to include a hash digest of the data in the OP_RETURN and maintain a distributed hash table that links the full data to its hash value.

### 3.1.3 Standard Transaction Fields

Another way to include token data in the transaction is to map it directly to fields that already exist within the transaction. In particular, the locking script can be used to define the conditions for transfer of the token (e.g. being able to produce a signature that corresponds to a particular public key). Additionally, some fields such as the transaction version (a 4-byte integer) are not currently used, and these can be used to flag a transaction as part of a token system. Similarly, if the locktime is set to 0, the nSequence field (4-byte integer) becomes moot, and so it can be used to encode a value. This approach does not affect the size of the transaction and so minimises transaction fees, but the amount of data that may be encoded in the transaction is limited.

### 3.1.4 UTXOs

Transaction outputs are unique elements within the blockchain system that can have one of two states: unspent (initial state) or spent (final state). It is possible to tie each token to an unspent transaction output (UTXO), and create a token rule where for every UTXO that is spent, a new, paired UTXO is created within the same transaction (see Section 3.4), that is the new instantiation of the same token. A UTXO-based token system makes use of the double-spend prevention that is inherent to the blockchain 150 to ensure that each token remains unique and has a verifiable history.

### 3.2 Fungibility

Fungibility is the extent to which the asset the token represents is unique and non-divisible. A fungible asset is non-unique and may be divided into parts. For example, a fungible token might represent a 10% share in a company; there may up to 10 ‘10% shares’ of that company, and each functions identically to the others—they are interchangeable. It is also possible to split the 10% share into two 5% shares without interfering with the function or value of the share.

In contrast, a non-fungible asset is a unique object that cannot be broken down into component parts. A non-fungible token (NFT) might represent a house or a piece of unique digital artwork. Each token represents a particular instance that is not interchangeable with a like asset (e.g., a house is not the same as its neighbour) and cannot be split into component parts. NFTs can be thought of as digital twins, with the tokens having a 1:1 mapping to the represented asset.

Note that fungibility is not tied to value—for example, the fiat value of both company shares (fungible) and a house (non-fungible) can vary according to markets.

### 3.3. Verification

### 3.3.1 Trusted Third Party

One verification method that avoids checking the transaction chain history explicitly is to use a trusted third party (TTP), for example the token issuer. The TTP keeps track of every transaction as it occurs, verifying that it satisfies the token ruleset and contains an input from a transaction they have previously verified. This means that when Txₙ is created, all transactions Tx₀, . . . , Txₙ₋₁ have already been verified by the TTP, and the TTP need only verify that Txₙ follows the token ruleset. The tokens transactions are created such that they require a signature from the token issuer In order to be valid on the blockchain network 106. Thus, if a transaction is published on the blockchain 150, a user can be sure that it was verified and signed by the token issuer.

This solution is lightweight from the user's perspective, as they are not required to run any verification themselves. It is also efficient from the TTP's perspective as token transactions need only be verified once. However, it requires a secure, verifiable connection between the user and the TTP. It also relies on the trust in the TTP, and the assumption that they will remain available as a service provider as long as users still require the service.

### 3.3.2 Transaction Chain Proof

For this verification method, the token issuer creates a proof that transaction Txₙ is linked to transaction Tx₀ through an unbroken chain of transactions—the transaction chain proof (TCP). The TCP is of a constant size regardless of the length of the transaction chain. TCPs use recursive zkSNARKs, a form of zero-knowledge proof, so the user can verify the proof without knowledge of the full data that comprises the transaction chain. The recursive property means that the work used to create the proof of the previous transaction in the chain can be reused when creating the updated proof, so the proofs can be efficiently generated.

Each TCP proves the following:
i. The new transaction Txₙ satisfies the token ruleset.
ii. Either the previous transaction Txₙ₋₁ has a valid proof, or it is the issuance transaction Tx₀.

The proof circuit is constructed based on the token ruleset with a unique token identifier hardcoded into the initial proof. Once established, each subsequent transaction in the chain for that token uses the same ZKP circuit.

The proof size depends on the ZKP implementation. These come with different security and efficiency trade-offs. For example, Groth16 requires a proof size of 1.5 kB but requires a trusted setup per-circuit. Whereas Halo requires a proof size of 3.5 kB but does not require a trusted setup.

The proof can be stored on-chain within the transaction it verifies (for example in a non-spendable output), to provide a complete on-chain record of the validity of each token. This also means that a user can determine whether a transaction is valid without connecting to the token issuer to request information. Alternatively, if minimising transaction sizes is a factor, the proofs can be stored externally (for example by the token issuer or in a distributed database) and accessed on-demand by a user via secure connection.

TCPs assume that the token issuer constructs proofs for each new token transaction, and potentially stores these proofs and sends them to users when required. However, the TCP can be constructed by anyone, and their validity can be explicitly checked. This means that while the token issuer provides a continued service to users, they do not need to be a trusted party.

Miners play no role in the creation or verification of these proofs, and the proofs themselves do not involve Bitcoin script, so there is no additional processing or burden placed on miners. However, verifying the proof does require that the user has the capability to run the proof circuit.

### 3.3.3 Miner-Validated Tokens (MVT)

This verification method is built using a particular locking script template. It is made up of three parts: a fixed element that encodes the token ruleset, an element containing a unique token identifier, and a customisable element for any other spending conditions such as a Pay-to-Public-Key-Hash script.

The MVT fixed element and token identifier ensure that Txₙ is a valid token transaction if and only if the same locking script appears in both the parent transaction Txₙ₋₁ and the grandparent transaction Txₙ₋₂, unless it is the issuance transaction.

As a result, the successful spending of a child MVT locking script ensures that the parent has the same locking script. Therefore, by induction we know that every transaction in the chain has the same locking script all the way back to the issuance transaction. Moreover, due to the uniqueness of the token identifier these scripts cannot be copied and successfully executed. This makes the protocol secure against replay attacks.

A key feature of the MVT technique is that it avoids transaction bloat where the unlocking script of every new transaction is bigger than the unlocking script of the previous transaction. Specifically, an MVT unlocking script only contains information about the two previous transactions regardless of how many transactions are in the chain. This is achieved by introducing an auxiliary transaction, and the implementation of a partial SHA-256 hashing algorithm via opcodes in the locking scripts.

MVT transactions are of a constant size, and the requirements to validate the proof do not increase as the transaction chain grows. This means that they, like TCPs, are a scalable solution. The verification of the token is also hard-coded into the locking script of the transaction, so there is no need for a TTP, and users do not need to explicitly validate the transaction chain—if a transaction is included in the blockchain 150, it proves that it and its chain history are valid.

MVTs are technically validated by miners of the blockchain network 106, but crucially they do not need to alter their transaction verification process to accommodate the token validation, since the token validation is implemented within the locking script. However, it places the computational burden of verification on miners.

3.4 S|ACP signed input-output pairs

For UTXO-based token systems one requires that the token input UTXO is paired with an output that serves as the new UTXO associated with the token. This pairing between a single input and output lends itself to implementation via a SINGLE ANYONE CAN PAY (S|ACP) signed input-output pair.

When creating a signature, the ECDSA algorithm used in transactions requires both a private key and a message. The message is formed based on some of the details of the transaction. The verification of a signature provides:
authorisation to spend the UTXO input it applies to, and
authentication of the transaction details in the signature message.

Each signature contains a sighash flag that indicates which inputs and outputs are signed. The S|ACP flag variant secures the input that the signature validates the spend of, and the output in the corresponding index position. Table 2 shows, in bold text, the information that would be secured if a S|ACP signature (Sig₁) was created to authorise input 1. An input-output pair signed using S|ACP places no restrictions on the information in other inputs or outputs, so multiple S|ACP-signed pairs can be combined together into a single transaction without any of the signatures being invalidated. This lends itself to applications where multiple input-output pairs that require signatures from different parties are combined into a single transaction (e.g. combining multiple token transfers signed by different users into a single transaction). Combining pairs in this way results in a small reduction in the necessary transaction fee, but also means that a single Merkle proof can be stored that applies to all the pairs within the transaction.

TxID

| Version | ver | | In | 1 |
|---|---|---|---|---|
| | | | Count | |
| Locktime | nLocktime | | Out | 2 |
| | | | Count | |
| Inputs | | | Outputs | |
| Outpoint | Unlocking script | nSeq | Value | Locking script |
| TxID₀ \|\| | < Sig₀ >< PK₀ > | n₀ | x₀ | [Checksig PK₂] |
| Index₀ | | | | |
| TxID₁ \|\| | < Sig₁S\|ACP > | n₁ | x₁ | [Checksig PK₃] OP_RETURN |
| Index₁ | < PK₁ > | | | <data> |

### 2. Example System Overview

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

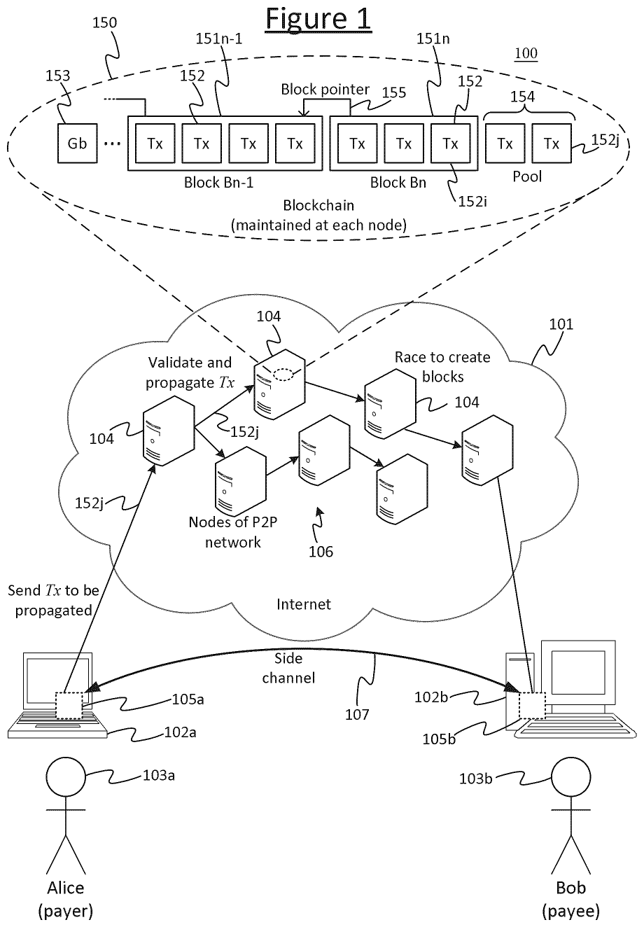

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 (often referred to as “miners”) that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout.

A blockchain node 104 may be configured to forward transactions 152 to other blockchain nodes 104, and thereby cause transactions 152 to be propagated throughout the network 106. A blockchain node 104 may be configured to create blocks 151 and to store a respective copy of the same blockchain 150 in their respective memory. A blockchain node 104 may also maintain an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Any given blockchain node may be configured to perform one or more of the following operations: validating transactions, storing transactions, propagating transactions to other peers, performing consensus (e.g. proof-of-work)/mining operations. In some examples, each type of operation is performed by a different node 104. That is, nodes may specialise in particular operation. For example, a nodes 104 may focus on transaction validation and propagation, or on block mining. In some examples, a blockchain node 104 may perform more than one of these operations in parallel. Any reference to a blockchain node 104 may refer to an entity that is configured to perform at least one of these operations.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106.

The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position” or “nonce”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

Some account-based transaction models share several similarities with the output-based transaction model described herein. For example, as mentioned above, the data field of an account-based transaction may point back to a previous transaction, which is equivalent to the input of an output-based transaction which references an outpoint a previous transaction. Thus both models enable linking between transactions. As another example, an account-based transaction contains a “recipient” field (in which a receiving address of an account is specified) and a “value” field (in which an amount of digital asset may be specified). Together the recipient and value fields are equivalent to the output of an output-based transaction which may be used to assign an amount of digital asset to a blockchain address. Similarly, an account-based transaction has a “signature” field which includes a signature for the transaction. The signature is generated using the sender's private key and confirms the sender has authorized this transaction. This is equivalent to an input/unlocking script of an output-based transaction which, typically, includes a signature for the transaction. When both types of transaction are submitted to their respective blockchain networks, the signatures are checked to determine whether the transaction is valid and can be recorded on the blockchain. On an account-based blockchain, a “smart contact” refers to a transaction that contains a script configured to perform one or more actions (e.g. send or “release” a digital asset to a recipient address) in response to one or more inputs (provided by a transaction) meeting one or more conditions defined by the smart contact's script. The smart contract exists as a transaction on the blockchain, and can be called (or triggered) by subsequent transactions. Thus, in some examples, a smart contract may be considered equivalent to a locking script of an output-based transaction, which can be triggered by a subsequent transaction, and checks whether one or more conditions defined by the locking script are met by the input of the subsequent transaction.

### 3. UTXO-Based Model

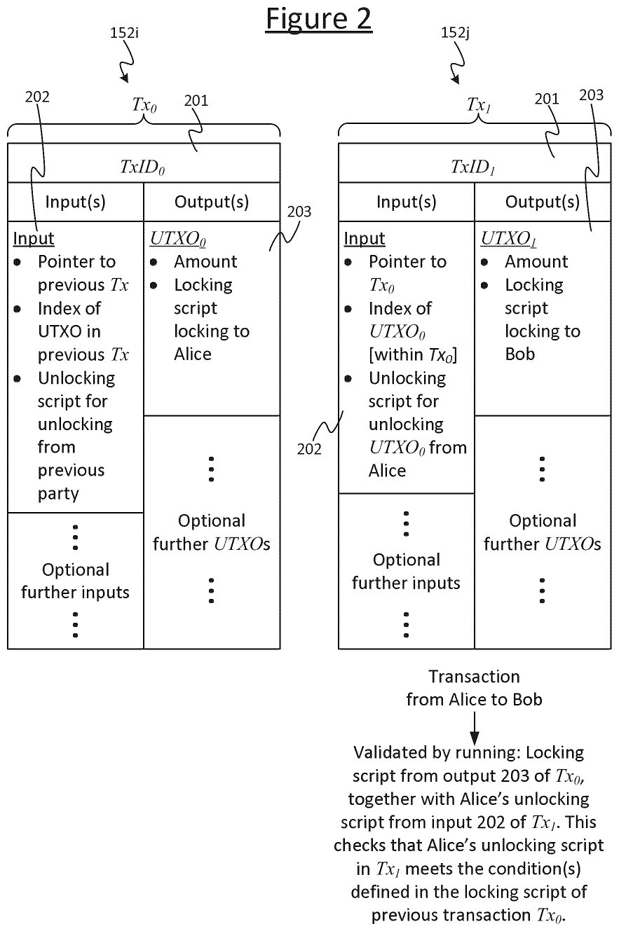

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx-”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Locking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria).

Note that the script code is often represented schematically (i.e. not using the exact language). For example, one may use operation codes (opcodes) to represent a particular function. “OP_. . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 4. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 5. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.

Statement 1. A computer-implemented method of issuing digital tokens using a blockchain, wherein the method is performed by a token issuer and comprises:
sending an issuance transaction to one or more nodes of a blockchain network, wherein the issuance transaction is signed by the token issuer and comprises a first token identifier, the first token identifier being based on at least first token data related to a first token;
obtaining a first proof of inclusion proving the issuance transaction has been recorded on the blockchain; and
maintaining a database, wherein the database comprises the first token identifier mapped to the issuance transaction and the first proof of inclusion, wherein the database is made available to one or more token users.

The proof of inclusion may be a Merkle proof.

Statement 2. The method of statement 1, wherein the issuance transaction comprises i) a first token input, the first token input comprising a signature of the token issuer, ii) a first token output locked to a public key of the token issuer and/or a first token user.

Statement 3. The method of statement 2, wherein the first token input has an input index corresponding to an output index of the first token output.

Statement 4. The method of statement 2 or statement 3, wherein the signature signs a message based on the first token output.

Statement 5. The method of any preceding statement, comprising:
sending a first transfer transaction to one or more nodes of the blockchain network and/or the first token user, wherein the first transfer transaction comprises the first token identifier;
obtaining a second proof of inclusion proving the first transfer transaction has been recorded on the blockchain; and
updating the database by mapping the first token identifier to the first transfer transaction and the second proof of inclusion.

Statement 6. The method of statement 5, wherein the first transfer transaction comprises
i) a first token input, the first token input comprising at least a signature of the token issuer,
ii) a first token output locked to a public key of first token user.

The first token output may have an input index corresponding to an output index of the first token output. The signature may sign a message based on the first token output.

Statement 7. The method of any preceding statement, comprising:
obtaining one or more respective transfer transactions, each forming a chain of transfer transactions linked back to the issuance transaction, wherein each respective transfer transaction comprises the first token identifier;
for each respective transfer transaction, obtaining a respective proof of inclusion proving the respective transfer transaction has been recorded on the blockchain; and
updating the database by mapping the first token identifier to each respective transfer transaction and each respective proof of inclusion.

Each respective transfer transaction may comprises i) a respective token input, the respective token input comprising a respective signature of a respective token user, ii) a respective token output locked to at least a respective public key of a respective token user.

The respective token input may have an input index corresponding to an output index of the respective token output. The respective signature may sign a respective message based on the respective token output.

Statement 8. The method of any preceding statement, wherein the database comprises a hash table.

Statement 9. The method of any preceding statement, wherein the first token identifier comprises commitment to the first token data.

Statement 10. The method of statement 9, wherein the first token identifier comprises a first token hash, the first token hash being generated by inputting at least the first token data into a hash function.

Alternatively, the first token identifier may comprise a Pederson commitment of the first token data, or a uniform resource locator, URL, referencing the first token data.

Statement 11. A computer-implemented method of validating digital tokens issued using a blockchain, wherein the blockchain comprises an issuance transaction signed by a token issuer and comprising a first token identifier, the first token identifier being based on at least first token data related to a first token, and wherein the method is performed by a token validator and comprises:
obtaining a target transfer transaction, wherein the target transfer is a final transaction of a chain of one or more respective transfer transactions linked back to the issuance transaction, and wherein the target transfer transaction comprises the first token identifier;
obtaining a database, wherein the database comprises the first token identifier mapped to the issuance transaction, a first proof of inclusion proving the issuance transaction has been recorded on the blockchain, and a target proof of inclusion proving that the target transfer transaction has been recorded on the blockchain; and
determining that the target transfer transaction comprises a valid token by performing at least the following:
i) using the first proof of inclusion to verify that the issuance transaction has been recorded on the blockchain,
ii) using the target proof of inclusion to verify that the target transfer transaction has been recorded on the blockchain, and
iii) verifying that the target transfer transaction is linked to the issuance transaction.

Statement 12. The method of statement 11, wherein said verifying that the target transfer transaction is linked to the issuance transaction comprises obtaining each transaction in the chain of one or more respective transfer transactions.

Statement 13. The method of statement 11 or statement 12, wherein the first token identifier is mapped to each transaction in the chain of one or more respective transfer transactions.

Statement 14. The method of any of statements 11 to 13, wherein the first token identifier is mapped to a respective proof of inclusion proving each respective transfer transaction has been recorded on the blockchain, and wherein said determining that the target transfer transaction comprises a valid token further comprises:
iv) using each respective proof of inclusion to verify that each respective transfer transaction has been recorded on the blockchain.

Statement 15. The method of any of statements 11 to 14, wherein the token validator is a first token user, wherein the target transfer transaction comprises a token output locked to a public key of the first token user, and wherein the method comprises transferring the first token to a second token user by:
generating a further transfer transaction, wherein the further transfer transaction comprises i) a first token input, the first token input comprising a signature of the first token user, ii) a first token output locked to a public key of the second token user, and iii) the first token identifier; and
sending the further transfer transaction to one or more nodes of the blockchain network and/or the second token user.

Statement 16. Computer equipment comprising:
memory comprising one or more memory units; and
processing apparatus comprising one or more processing units, wherein the memory stores code arranged to run on the processing apparatus, the code being configured so as when on the processing apparatus to perform the method of any of statements 1 to 15.

Statement 17. A computer program embodied on computer-readable storage and configured so as, when run on one or more processors, to perform the method of any of statements 1 to 15.

According to another aspect disclosed herein, there may be provided a method comprising the actions of the token issuer and he token validator. According to another aspect disclosed herein, there may be provided a system comprising the computer equipment of the token issuer and the token validator.

1. A computer-implemented method of issuing digital tokens using a blockchain, wherein the method is performed by a token issuer and comprises:
constructing an issuance transaction, wherein the issuance transaction is signed by the token issuer and comprises a first token identifier, the first token identifier being based on at least first token data related to a first token;
generating a digital signature based on the issuance transaction;
sending the issuance transaction to one or more nodes of a blockchain network;
obtaining a first proof of inclusion proving the issuance transaction has been recorded on the blockchain; and
maintaining a database, wherein the database comprises the first token identifier mapped to the issuance transaction and the first proof of inclusion, wherein the database is made available to one or more token users.

2. The method of claim 1, wherein the issuance transaction comprises i) a first token input, the first token input comprising a signature of the token issuer, ii) a first token output locked to a public key of the token issuer and/or a first token user.

3. The method of claim 2, wherein the first token input has an input index corresponding to an output index of the first token output.

4. The method of claim 2, wherein the signature signs a message based on the first token output.

5. The method of claim 1, comprising:
sending a first transfer transaction to one or more nodes of the blockchain network and/or the first token user, wherein the first transfer transaction comprises the first token identifier;
obtaining a second proof of inclusion proving the first transfer transaction has been recorded on the blockchain; and
updating the database by mapping the first token identifier to the first transfer transaction and the second proof of inclusion.

6. The method of claim 5, wherein the first transfer transaction comprises i) a first token input, the first token input comprising at least a signature of the token issuer, ii) a first token output locked to a public key of first token user.

7. The method of claim 1, comprising:
obtaining one or more respective transfer transactions, each forming a chain of transfer transactions linked back to the issuance transaction, wherein each respective transfer transaction comprises the first token identifier;
for each respective transfer transaction, obtaining a respective proof of inclusion proving the respective transfer transaction has been recorded on the blockchain; and
updating the database by mapping the first token identifier to each respective transfer transaction and each respective proof of inclusion.

8. The method of claim 1, wherein the database comprises a hash table.

9. The method of claim 1, wherein the first token identifier comprises commitment to the first token data.

10. The method of claim 9, wherein the first token identifier comprises a first token hash, the first token hash being generated by inputting at least the first token data into a hash function.

11. A computer-implemented method of validating digital tokens issued using a blockchain, wherein the blockchain comprises an issuance transaction signed by a token issuer and comprising a first token identifier, the first token identifier being based on at least first token data related to a first token, and wherein the method is performed by a token validator and comprises:
obtaining a target transfer transaction, wherein the target transfer is a final transaction of a chain of one or more respective transfer transactions linked back to the issuance transaction, and wherein the target transfer transaction comprises the first token identifier;
obtaining a database, wherein the database comprises the first token identifier mapped to the issuance transaction, a first proof of inclusion proving the issuance transaction has been recorded on the blockchain, and a target proof of inclusion proving that the target transfer transaction has been recorded on the blockchain; and
determining that the target transfer transaction comprises a valid token by performing at least the following:
i) using the first proof of inclusion to verify that the issuance transaction has been recorded on the blockchain,
ii) using the target proof of inclusion to verify that the target transfer transaction has been recorded on the blockchain, and
iii) verifying that the target transfer transaction is linked to the issuance transaction.

12. The method of claim 11, wherein said verifying that the target transfer transaction is linked to the issuance transaction comprises obtaining each transaction in the chain of one or more respective transfer transactions.

13. The method of claim 11, wherein the first token identifier is mapped to each transaction in the chain of one or more respective transfer transactions.

14. The method of claim 11, wherein the first token identifier is mapped to a respective proof of inclusion proving each respective transfer transaction has been recorded on the blockchain, and wherein said determining that the target transfer transaction comprises a valid token further comprises:
iv) using each respective proof of inclusion to verify that each respective transfer transaction has been recorded on the blockchain.

15. The method of claim 11, wherein the token validator is a first token user, wherein the target transfer transaction comprises a token output locked to a public key of the first token user, and wherein the method comprises transferring the first token to a second token user by:
generating a further transfer transaction, wherein the further transfer transaction comprises i) a first token input, the first token input comprising a signature of the first token user, ii) a first token output locked to a public key of the second token user, and iii) the first token identifier; and
sending the further transfer transaction to one or more nodes of a blockchain network and/or the second token user.

16. (canceled)

17. A non-transitory computer readable medium comprising a computer program configured so as, when run on one or more processors, the one or more processors a method of of issuing digital tokens using a blockchain, wherein the method is performed by a token issuer and comprises:
constructing an issuance transaction, wherein the issuance transaction is signed by the token issuer and comprises a first token identifier, the first token identifier being based on at least first token data related to a first token;
generating a digital signature based on the issuance transaction;
sending the issuance transaction to one or more nodes of a blockchain network;
obtaining a first proof of inclusion proving the issuance transaction has been recorded on the blockchain; and
maintaining a database, wherein the database comprises the first token identifier mapped to the issuance transaction and the first proof of inclusion, wherein the database is made available to one or more token users.
